(19) United States
(12) Patent Application Publication
(10) Pub. No.: US 2023/0027813 A1
(43) Pub. Date: Jan. 26, 2023

(54) OBJECT DETECTING METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Xipeng YANG, Beijing (CN); Xiao TAN, Beijing (CN); Hao SUN, Beijing (CN); Errui DING, Beijing (CN)

(21) Appl. No.: 17/936,570

(22) Filed: Sep. 29, 2022

(30) Foreign Application Priority Data
Sep. 30, 2021 (CN) 202111160333.7

(51) Int. Cl. G06T 7/73; G06V 10/44

(52) U.S. Cl. CPC G06T 7/73; G06V 10/44

(57) ABSTRACT

An object detecting method includes: obtaining an object image of an object; obtaining an object feature map by performing feature extraction on the object image; obtaining decoded features by performing feature mapping on the object feature map by adopting a mapping network of an object recognition model; obtaining positions of prediction boxes by inputting the decoded features into a first prediction layer of the object recognition model to perform object regression prediction; and obtaining classes of objects within the prediction boxes by inputting the decoded features into a second prediction layer of the object recognition model to perform object class prediction.

### CROSS REFERENCE TO RELATED APPLICATIONS

This application claims priority and benefits to Chinese Application No. 202111160333.7, filed on Sep. 30, 2021, the entire disclosure of which is incorporated herein by reference.

### TECHNICAL FIELD

The disclosure relates to fields of artificial intelligence (AI), especially computer vision and deep learning technologies, and in particular to an object detecting method, an object detecting apparatus, an electronic device and a storage media. The disclosure can be applied in object detection and video analysis scenes.

### BACKGROUND

In the scenarios of smart city, intelligent transportation and video analysis, accurate detection of vehicles, pedestrians, objects or targets in an image or in video frames of a video can provide help for tasks, such as abnormal event detection, criminal tracking and vehicle statistics.

### SUMMARY

According to a first aspect, an object detecting method is provided. The method includes:

obtaining an object image;

obtaining an object feature map by performing feature extraction on the object image;

obtaining decoded features by performing feature mapping on the object feature map by adopting a mapping network of an object recognition model;

obtaining positions of prediction boxes by inputting the decoded features into a first prediction layer of the object recognition model to perform object regression prediction; and

obtaining classes of objects within the prediction boxes by inputting the decoded features into a second prediction layer of the object recognition model to perform object class prediction.

According to a second aspect, an electronic device is provided. The electronic device includes: at least one processor and a memory communicatively coupled to the at least one processor. The memory stores instructions executable by the at least one processor, and when the instructions are executed by the at least one processor, the object detecting method according to the first aspect of the disclosure is implemented.

According to a third aspect of the disclosure, a non-transitory computer-readable storage medium having computer instructions stored thereon is provided. The computer instructions are configured to cause a computer to implement the object detecting method according to the first aspect of the disclosure.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure.

FIG. 1 is a block diagram illustrating a Transformer model.

FIG. 2 is a flowchart illustrating an object detecting method according to some examples of the disclosure.

FIG. 3 is a flowchart illustrating an object detecting method according to some examples of the disclosure.

FIG. 4 is a schematic diagram illustrating an object detecting principle according to some examples of the disclosure.

FIG. 5 is a schematic diagram illustrating a process of fusing an object feature map and a position map according to some examples of the disclosure.

FIG. 6 is a flowchart illustrating an object detecting method according to some examples of the disclosure.

FIG. 7 is a schematic diagram illustrating an object detecting apparatus according to some examples of the disclosure.

FIG. 8 is a block diagram illustrating an electronic device configured to implement the embodiments of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

Currently, in the object detecting scheme based on Detection Transformer (DTER, i.e., the visual version of Transformer), after the Transformer module outputs features, classification features and regression features are undistinguished.

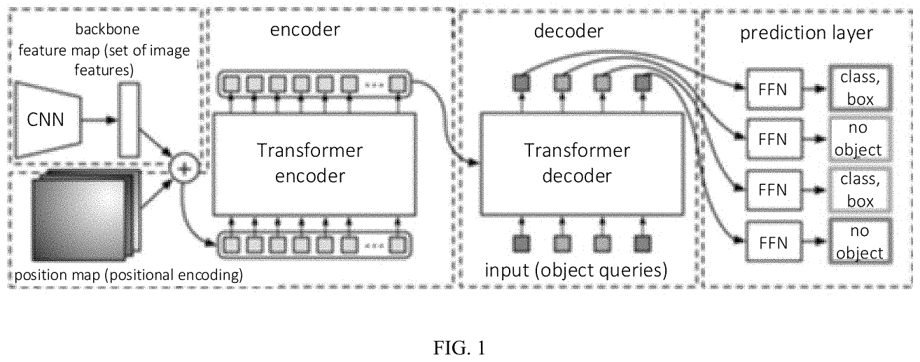

For example, the structure of the conventional Transformer model is illustrated as FIG. 1. The decoded features output by the decoder in the Transformer can be directly inputted to the Feed-Forward Networks (FFNs) to perform the classification and regression prediction at the same time. In FIG. 1, the term “CNN” is short for Convolutional Neural Network, the term “box” refers to the position of the prediction box outputted by the model, the term “class” refers to the class of the object within the prediction box outputted by the model, and the term “no object” refers to no object detected.

However, the confusion of the classification features and the regression features may not be conducive to focal feature expression. That is, since the classification focuses on global, contour and detail features, while the regression focuses on contour and leftover information, confused feature expressions of the classification and the regression are not conducive to feature extraction.

In view of the above problems, the disclosure provides an object detecting method, to enhance the feature expression capability of the model by decoupling the classification and the regression, thereby improving the object detecting effect.

The object detecting method, the object detecting apparatus, the electronic device and the storage medium according to examples of the disclosure will described below with reference to the accompanying drawings.

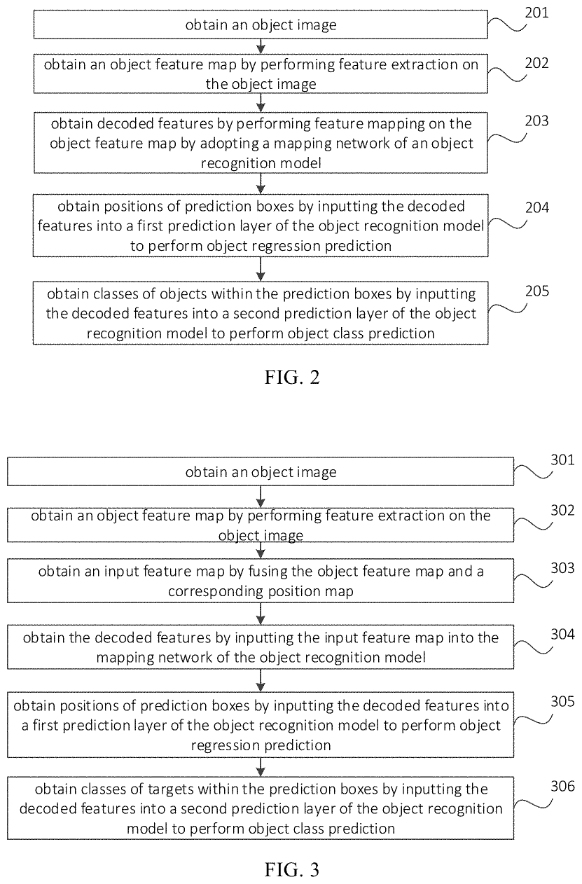

FIG. 2 is a flowchart illustrating an object detecting method according to some examples of the disclosure.

The object detecting method can be performed by an object detecting apparatus. The object detecting apparatus can be included in an electronic device or can be an electronic device, so that the electronic device is configured to perform the object detecting function.

The electronic device can be any device with computing capabilities, such as a personal computer, a mobile terminal and a server. The mobile terminal may be, for example, a vehicle-mounted device, a mobile phone, a tablet computer, a personal digital assistant, a wearable device, and other hardware devices with various operating systems, touch screens and/or display screens.

As illustrated in FIG. 2, the object detecting method includes the following steps.

In step 201, an object image is obtained.

The object image is an image that needs to perform the object detection. The object image can be obtained online, for example through web crawler technology. Alternatively, the object image can be obtained offline or captured in real time or an artificially synthesized image, which is not limited in the disclosure.

It is understandable that the object image can be a certain video frame of a video, and thus the object image can be extracted from a video. The above-mentioned “video” is also called a video to be detected, and the mode of obtaining the video to be detected is similar to the mode of obtaining the image, which is not limited here.

In step 202, an object feature map is obtained by performing feature extraction on the object image.

The feature extraction may be performed on the object image to obtain the object feature map corresponding to the object image.

In a possible implementation, in order to improve the accuracy and reliability of the feature extraction result, the feature extraction can be performed on the object image based on the deep learning technology, to obtain the object feature map corresponding to the object image.

For example, the mainstream backbone network can be used to perform the feature extraction on the object image, to obtain the object feature map. For example, the backbone network can be a residual network (ResNet), such as ResNet 34, ResNet 50 and ResNet 101, or a DarkNet (an open source neural network framework written in C and CUDA), such as DarkNet19 and DarkNet53.

For example, the CNN illustrated in FIG. 1 can be configured to perform the feature extraction on the object image, to obtain the object feature map. The object feature map outputted by the CNN network is a three-dimensional feature map of W (width)×H (height)×C (channel or feature dimension).

In a possible implementation, in order to improve the accuracy of the feature extraction result and save resources, a suitable backbone network can be selected to perform the feature extraction on the object image according to the service application scenes. For example, the backbone network can be classified as a lightweight structure (such as ResNet18, ResNet34 and DarkNet19), a medium-sized structure (such as ResNet50, ResNeXt 50 which is the combination of ResNet and Inception which is a kind of convolutional neural network and DarkNet53), and a heavy structure (such as ResNet101 and ResNeXt152). The specific network structure can be selected according to the application scenario.

In step 203, decoded features are obtained by performing feature mapping on the object feature map by adopting a mapping network of an object recognition model.

The structure of the object recognition model is not limited here. For example, the object recognition model can use the Transformer as a basic structure, or use other structures, such as a variant structure of the Transformer.

The mapping network can include an encoder and a decoder. In an example where the object recognition model uses the Transformer as the basic structure, the mapping network can be a Transformer module, and the Transformer module can include an encoder and a decoder.

The mapping network of the object recognition model can be configured to perform the feature mapping on the object feature map, to obtain the decoded features.

In step 204, positions of prediction boxes are obtained by inputting the decoded features into a first prediction layer of the object recognition model to perform object regression prediction.

The decoded features can be input into the first prediction layer of the object recognition model to perform the object regression prediction, to obtain the positions of the prediction boxes.

In step 205, classes of objects within the prediction boxes are obtained by inputting the decoded features into a second prediction layer of the object recognition model to perform object class prediction.

The second prediction layer and the first prediction layer are different prediction layers.

The object can be a vehicle, a human being, a target such as a building, an animal, or the like, and the class includes such as vehicle and human being.

It is noteworthy that, since the classification focuses on global, contour and detail features, while the regression focuses on contour and leftover information, the confusion of the classification features and the regression features may not be conducive to feature extraction.

Therefore, the classification branch and the regression branch are decoupled to enhance the feature expression capability of the model. That is, the classification prediction and regression prediction are decoupled, the first prediction layer is configured to perform the object regression prediction on the decoded features to obtain the positions of the prediction boxes, and the second prediction layer is configured to perform the object class prediction on the decoded features to obtain the classes of the objects within the prediction boxes.

With the object detecting method according to the disclosure, the object feature map is obtained by performing the feature extraction on the object image. The decoded features are obtained by performing the feature mapping on the object feature map by adopting the mapping network of the object recognition model. The positions of the prediction boxes are obtained by inputting the decoded features into the first prediction layer of the object recognition model to perform the object regression prediction. The classes of the objects within the prediction boxes are obtained by inputting the decoded features into the second prediction layer of the object recognition model to perform the object class prediction. In this way, the classification and the regression can be decoupled. Therefore, the model focuses on the feature expression capabilities of the classification and the regression, that is, the feature expression capability of the model is enhanced and the object detecting effect is improved.

In order to clearly illustrate how to adopt the mapping network to perform the feature mapping on the object feature map to obtain decoded features in the above examples, the object detecting method further includes the following.

FIG. 3 is a flowchart illustrating an object detecting method according to some examples of the disclosure.

As illustrated in FIG. 3, the object detecting method includes the following steps.

In step 301, an object image is obtained.

In step 302, an object feature map is obtained by performing feature extraction on the object image.

For the execution process of steps 301 to 302, reference may be made to the execution process of any embodiment of the disclosure, and details are not described herein.

In step 303, an input feature map is obtained by fusing the object feature map and a corresponding position map.

The elements of the position map correspond to the elements of the object feature map respectively. The element of the position map is configured to indicate a coordinate, in the object image, of the corresponding element of the object feature map.

In a possible implementation, the object feature map and the corresponding position map are spliced to obtain the input feature map.

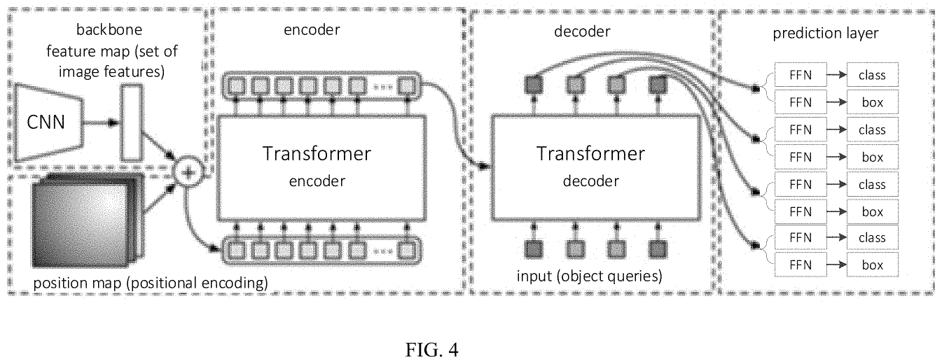

In an example where the object recognition model uses the Transformer as the basic structure, the object detecting principle is illustrated as FIG. 4, where the object feature map outputted by the CNN and the position map can be added or spliced to obtain the input feature map.

In a possible implementation, the object feature map and the corresponding position map can be spliced to obtain a spliced feature map. The spliced feature map can be input into the convolutional layer for fusing to obtain the input feature map.

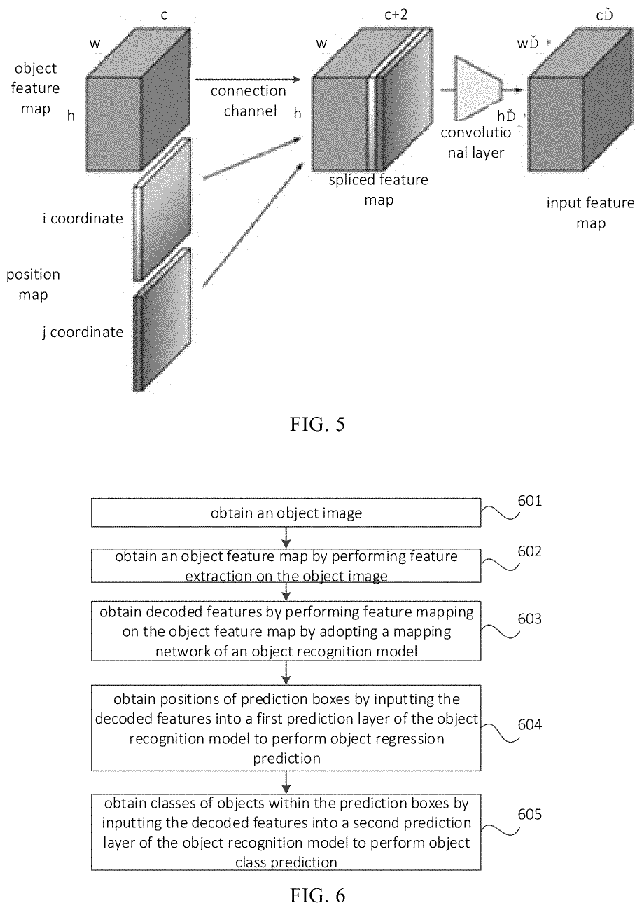

For example, the input feature map can be obtained by fusing the object feature map with the corresponding position map through the convolution layer shown in FIG. 5. In FIG. 5, in the position map, i component (or also called i coordinate) refers to the X-axis coordinate in the coordinates of the elements in the object image, and j element (or also called j coordinate) refers to the Y-axis coordinate in the coordinates of the elements in the object image.

That is, the object feature map w×h×c can be spliced with the i coordinates and the j coordinates of the corresponding position map, to obtain the spliced feature map w×h×(c+2), and spliced feature map can be input into the convolutional layer for fusing to obtain the input feature map w′×h′×c′, where w denotes a plurality of width components in the object feature map, h denotes a plurality of height components in the object feature map, c denotes dimension components in the object feature map, w′ denotes a plurality of width components in the input feature map, h′ denotes a plurality of height components in the input feature map, and c′ denotes a plurality of dimension components in the input feature map.

In step 304, the decoded features are obtained by inputting the input feature map into the mapping network of the object recognition model.

The mapping network of the object recognition model may be configured to perform the feature mapping on the input feature map to obtain the decoded features.

In a possible implementation, the encoder in the mapping network can be configured to encode the input feature map to obtain the encoded features. The decoder in the mapping network can be configured to decode the encoded features, to obtain the decoded features. That is, the input feature map can be input into the encoder of the object recognition model for encoding to obtain the encoded features, and the encoded features can be input into the decoder of the object recognition model for decoding to obtain the decoded features.

Therefore, the encoder-decoder structure is configured to process the input feature map, that is, feature interaction can be performed on the input feature map based on attention mechanisms, such as self-attention and multi-head attention, to output the enhanced features, that is, the decoded features, thereby improving the prediction effect of the model.

In step 305, positions of prediction boxes are obtained by inputting the decoded features into a first prediction layer of the object recognition model to perform object regression prediction.

In step 306, classes of objects within the prediction boxes are obtained by inputting the decoded features into a second prediction layer of the object recognition model to perform the object class prediction.

For the execution process of steps 305 and 306, reference may be made to the execution process of any embodiment of the disclosure, and details are not described herein.

Taking the first prediction layer and the second prediction layer includes the FFN as an example for illustration, an improvement is made to the structure of the prediction layer in FIG. 1 to obtain the structure shown in FIG. 4. It is noteworthy that the prediction layer corresponding to one branch may include multiple FFNs connected in series, but in FIG. 4, the prediction layer corresponding to each branch includes one FFN.

In FIG. 1, one FFN is used for both the classification prediction and the regression prediction. In training the object recognition model, each FFN needs to learn a correspondence between one input and two outputs, such that the learning efficiency is low, which is not conducive to feature extraction.

In FIG. 4, one FFN only needs to learn the correspondence between one input and one output, which can improve the learning efficiency and enhance the feature expression capability.

With the object detecting method according to the disclosure, the input feature map is obtained by fusing the object feature map and the corresponding position map, the elements of the position map correspond to the elements of the object feature map respectively, and the element of the position map is configured to indicate the coordinate of the corresponding element of the object feature map in the object image. The input feature map is input into the mapping network of the object recognition model to obtain the decoded features. Therefore, the position map and the object feature map are fused for object detection, which improves the accuracy of the object detecting result.

In order to clearly illustrate how the object regression prediction and the object class prediction are performed on the encoded features in above examples, the object detecting method further includes the following.

FIG. 6 is a flowchart illustrating an object detecting method according to some examples of the disclosure.

As illustrated in FIG. 6, the object detecting method includes the following steps.

In step 601, an object image is obtained.

In step 602, an object feature map is obtained by performing feature extraction on the object image.

In step 603, decoded features are obtained by performing feature mapping on the object feature map by adopting a mapping network of an object recognition model.

For the execution process of steps 601 and 603, reference may be made to the execution process of any embodiment of the disclosure, and details are not described herein.

In a possible implementation, the object feature map is a three-dimensional feature map of H×W×C, and the three-dimensional object feature map can be divided into blocks to obtain a serialized feature vector sequence. That is, the object feature map is converted into H×W C-dimensional feature vectors. The serialized feature vector sequence is input to the encoder in the mapping network for attention learning, and the obtained feature vector sequence is input into the decoder in the mapping network. The decoder performs the attention learning based on the inputted feature vector sequence to obtain the decoded features.

In step 604, feature dimensions of the decoded features are input into respective feed-forward neural networks (FFNs) in the first prediction layer of the object recognition model to perform the object regression prediction to obtain the positions of the prediction boxes.

It is understandable that the object recognition model can identify a large number of objects, but the number of objects contained in an image is limited due to the limited framing screen of the image. In view of the accuracy of the object detecting result and in order to avoid resource waste, in the disclosure, the number of feature dimensions of the decoded features can be preset. The number of feature dimensions is related to the number of objects that can be identified in an image frame. For example, the number of feature dimensions can be related to the upper limit of the number of objects that can be identified in the image frame. For example, the number of feature dimensions can be between 100 and 200.

In the disclosure, the number of FFNs in the first prediction layer can be determined according to the number of feature dimensions. The number of FFNs in the first prediction layer is the same as the number of feature dimensions.

The feature dimensions of the decoded features can be input into the respective FFNs in the first prediction layer of the object recognition model to carry out the object regression prediction, to obtain the positions of the prediction boxes. For example, if the number of feature dimensions is 100, 100 FFNs in the first prediction layer can be used to perform object regression prediction on the 100 feature dimensions of the decoded features.

If the number of feature dimensions is 4, as shown in FIG. 4, the object regression prediction can be performed through 4 FFNs to obtain the 4 positions of 4 prediction boxes.

In step 605, the classes of objects within the prediction boxes are obtained by inputting feature dimensions of the decoded features into respective FFNs in the second prediction layer of the object recognition model to perform the object class prediction.

The feature dimensions of the decoded features can be input into the respective FFNs in the second prediction layer of the object recognition model to perform the object class prediction, to obtain the classes of the objects. For example, if the number of feature dimensions is 100, 100 FFNs in the second prediction layer can be used to perform the object class prediction object on the feature dimensions of the decoded features.

If the number of feature dimensions is 4, as shown in FIG. 4, the object class prediction can be performed through 4 FFNs to obtain 4 classes.

With the object detecting method according to the disclosure, the feature dimensions of the decoded features are input into the respective FFNs in the first prediction layer of the object recognition model to perform the object regression prediction, to obtain the positions of the prediction boxes. In this way, it is possible to effectively predict the position of the prediction box of each object contained in the object image through multiple FFNs.

By inputting the feature dimensions in the decoded features into the respective FFNs in the second prediction layer of the object recognition model to perform the object class prediction, the classes of the objects can be obtained. In this way, multiple FFNs can be used to effectively predict the class of each object contained in the object image.

Corresponding to the object detecting method according to the above examples of FIGS. 1 to 6, the disclosure also provides an object detecting apparatus. Since the object detecting apparatus corresponds to the object detecting method of the examples of FIG. 1 to FIG. 6, the embodiments of the object detecting method are also applicable to the object detecting apparatus, which will not be described in detail in the embodiments of the disclosure.

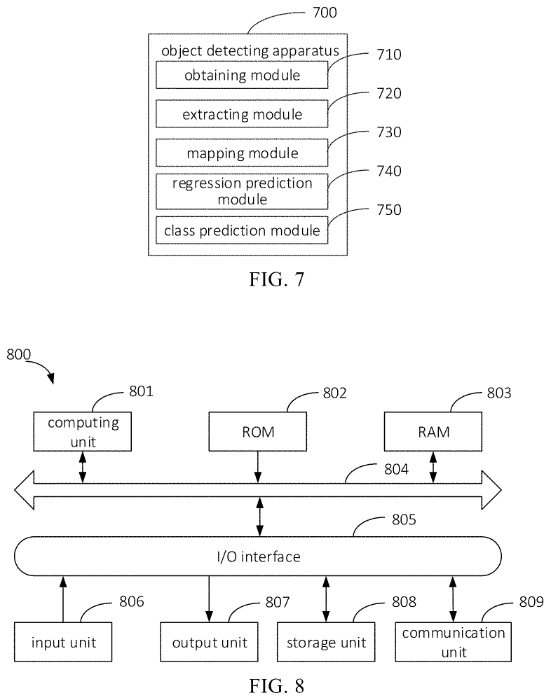

FIG. 7 is a schematic diagram illustrating an object detecting apparatus according to some examples of the disclosure.

As illustrated in FIG. 7, the object detecting apparatus 700 may include: an obtaining module 710, an extracting module 720, a mapping module 730, a regression prediction module 740 and a class prediction module 750.

The obtaining module 710 is configured to obtain an object image.

The extracting module 720 is configured to obtain an object feature map by performing feature extraction on the object image.

The mapping module 730 is configured to obtain decoded features by performing feature mapping on the object feature map by adopting a mapping network of an object recognition model.

The regression prediction module 740 is configured to obtain positions of prediction boxes by inputting the decoded features into a first prediction layer of the object recognition model to perform object regression prediction.

The class prediction module 750 is configured to obtain classes of objects within the prediction boxes by inputting the decoded features into a second prediction layer of the object recognition model to perform object class prediction.

In a possible implementation, the mapping module 730 further includes: a fusing unit and an inputting unit.

The fusing unit is configured to obtain an input feature map by fusing the object feature map and a corresponding position map. Elements of the position map correspond to elements of the object feature map respectively, and the element of the position map is configured to indicate a coordinate, in the object image, of the corresponding element of the object feature map.

The inputting unit is configured to obtain the decoded features by inputting the input feature map into the mapping network of the object recognition model.

In a possible implementation, the inputting unit is further configured to: obtain encoded features by inputting the input feature map into an encoder of the object recognition model for encoding; and obtain the decoded features by inputting the encoded features into a decoder of the object recognition model for decoding.

In a possible implementation, the regression prediction module 740 is further configured to: input feature dimensions of the decoded features into respective feed-forward neural networks (FFNs) in the first prediction layer of the object recognition model to perform the object regression prediction to obtain the positions of the prediction boxes.

In a possible implementation, the class prediction module 750 is further configured to: obtain the classes of the objects by inputting feature dimensions of the decoded features into respective feed-forward neural networks in the second prediction layer of the object recognition model to perform the object class prediction.

With the object detecting apparatus according to the disclosure, the object feature map is obtained by performing the feature extraction on the object image. The decoded features are obtained by performing the feature mapping on the object feature map by adopting the mapping network of the object recognition model. The positions of the prediction boxes are obtained by inputting the decoded features into the first prediction layer of the object recognition model to perform the object regression prediction. The classes of the objects within the prediction boxes are obtained by inputting the decoded features into the second prediction layer of the object recognition model to perform the object class prediction. In this way, decoupling of the classification and the regression can be achieved, so that the model focuses on the feature expression capabilities of the classification and the regression, that is, the feature expression capability of the model is enhanced and the object detecting effect is improved.

In order to realize the above embodiments, the disclosure provides an electronic device. The electronic device includes: at least one processor and a memory communicatively coupled to the at least one processor. The memory stores instructions executable by the at least one processor, and when the instructions are executed by the at least one processor, the object detecting method according to any embodiment of the disclosure is implemented.

In order to realize the above embodiments, the disclosure provides a non-transitory computer-readable storage medium having computer instructions stored thereon. The computer instructions are configured to cause a computer to implement the object detecting method according to any embodiment of the disclosure.

In order to realize the above-mentioned embodiments, the disclosure provides a computer program product including computer programs. When the computer programs are executed by a processor, the object detecting method according to any embodiment of the disclosure is implemented.

According to the embodiments of the disclosure, the disclosure also provides an electronic device, a readable storage medium and a computer program product.

FIG. 8 is a block diagram of an example electronic device used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 8, the device 800 includes a computing unit 801 performing various appropriate actions and processes based on computer programs stored in a read-only memory (ROM) 802 or computer programs loaded from the storage unit 808 to a random access memory (RAM) 803. In the RAM 803, various programs and data required for the operation of the device 800 are stored. The computing unit 801, the ROM 802, and the RAM 803 are connected to each other through a bus 804. An input/output (I/O) interface 805 is also connected to the bus 804.

Components in the device 800 are connected to the I/O interface 805, including: an inputting unit 806, such as a keyboard, a mouse; an outputting unit 807, such as various types of displays, speakers; a storage unit 808, such as a disk, an optical disk; and a communication unit 809, such as network cards, modems, and wireless communication transceivers. The communication unit 809 allows the device 800 to exchange information/data with other devices through a computer network such as the Internet and/or various telecommunication networks.

The computing unit 801 may be various general-purpose and/or dedicated processing components with processing and computing capabilities. Some examples of computing unit 801 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 801 executes the various methods and processes described above, such as the object detecting method. For example, in some embodiments, the method may be implemented as a computer software program, which is tangibly contained in a machine-readable medium, such as the storage unit 808. In some embodiments, part or all of the computer program may be loaded and/or installed on the device 800 via the ROM 802 and/or the communication unit 809. When the computer program is loaded on the RAM 803 and executed by the computing unit 801, one or more steps of the method described above may be executed. Alternatively, in other embodiments, the computing unit 801 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and a Block-chain network.

The computer system may include a client and a server. The client and server are generally remote from each other and interacting through a communication network. The client-server relation is generated by computer programs running on the respective computers and having a client-server relation with each other. The server can be a cloud server, also known as a cloud computing server or a cloud host, which is a host product in the cloud computing service system to solve management difficulty and weak business scalability defects in the traditional physical host and Virtual Private Server (VPS) service. The server can also be a distributed system server, or a server in combination with a block-chain.

It is noted that AI is a discipline that allow computers to simulate certain human thinking processes and intelligent behaviors (such as learning, reasoning, thinking and planning), which has both hardware-level technology and software-level technology. AI hardware technology generally includes technologies such as sensors, dedicated AI chips, cloud computing, distributed storage, and big data processing. AI software technology mainly includes computer vision technology, speech recognition technology, natural language processing technology, and machine learning/depth learning, big data processing technology, knowledge graph technology and other major directions.

According to the technical solution of the disclosure, the object feature map is obtained by performing the feature extraction on the object image. The decoded features are obtained by performing the feature mapping on the object feature map based on the mapping network of the object recognition model. The positions of the prediction box are obtained by inputting the decoded features into the first prediction layer of the object recognition model to perform the regression prediction of the object. The classes of the object within the prediction box are obtained by inputting the decoded features into the second prediction layer of the object recognition model to perform the class prediction of the object. In this way, the classification and the regression can be decoupled. Therefore, the model focuses on the feature expression capabilities of the classification and the regression, that is, the feature expression capability of the model is enhanced and the object detecting effect is improved.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. An object detecting method, comprising:
obtaining an object image;
obtaining an object feature map by performing feature extraction on the object image;
obtaining decoded features by performing feature mapping on the object feature map by adopting on a mapping network of an object recognition model;
obtaining positions of prediction boxes by inputting the decoded features into a first prediction layer of the object recognition model to perform object regression prediction; and
obtaining classes of objects within the prediction boxes by inputting the decoded features into a second prediction layer of the object recognition model to perform object class prediction.

2. The method of claim 1, wherein obtaining the decoded features comprises:
obtaining an input feature map by fusing the object feature map and a corresponding position map, wherein elements of the position map correspond to elements of the object feature map respectively, and the element of the position map is configured to indicate a coordinate, in the object image, of the corresponding element of the object feature map; and
obtaining the decoded features by inputting the input feature map into the mapping network of the object recognition model.

3. The method of claim 2, wherein obtaining the decoded features by inputting the input feature map into the mapping network of the object recognition model comprises:
obtaining encoded features by inputting the input feature map into an encoder of the object recognition model for encoding; and
obtaining the decoded features by inputting the encoded features into a decoder of the object recognition model for decoding.

4. The method of claim 1, wherein obtaining the positions of the prediction boxes comprises:
inputting feature dimensions in the decoded features into respective feed-forward neural networks in the first prediction layer of the object recognition model to perform the object regression prediction to obtain the positions of the prediction boxes.

5. The method of claim 1, wherein obtaining the classes of the objects within the prediction boxes comprises:
obtaining the classes of the objects by inputting feature dimensions in the decoded features into respective feed-forward neural networks in the second prediction layer of the object recognition model to perform the object class prediction.

6. An electronic device, comprising:
at least one processor; and
a memory communicatively coupled to the at least one processor;
wherein, the memory stores instructions executable by the at least one processor, when the instructions are executed by the at least one processor, the at least one processor is configured to:
obtain an object image;
obtain an object feature map by performing feature extraction on the object image;
obtain decoded features by performing feature mapping on the object feature map by adopting on a mapping network of an object recognition model;
obtain positions of prediction boxes by inputting the decoded features into a first prediction layer of the object recognition model to perform object regression prediction; and
obtain classes of objects within the prediction boxes by inputting the decoded features into a second prediction layer of the object recognition model to perform object class prediction.

7. The electronic device of claim 6, wherein the at least one processor is configured to:
obtain an input feature map by fusing the object feature map and a corresponding position map, wherein elements of the position map correspond to elements of the object feature map respectively, and the element of the position map is configured to indicate a coordinate, in the object image, of the corresponding element of the object feature map; and
obtain the decoded features by inputting the input feature map into the mapping network of the object recognition model.

8. The electronic device of claim 7, wherein the at least one processor is configured to:
obtain encoded features by inputting the input feature map into an encoder of the object recognition model for encoding; and
obtain the decoded features by inputting the encoded features into a decoder of the object recognition model for decoding.

9. The electronic device of claim 6, wherein the at least one processor is configured to:
input feature dimensions in the decoded features into respective feed-forward neural networks in the first prediction layer of the object recognition model to perform the object regression prediction to obtain the positions of the prediction boxes.

10. The electronic device of claim 6, wherein the at least one processor is configured to:
obtain the classes of the objects by inputting feature dimensions in the decoded features into respective feed-forward neural networks in the second prediction layer of the object recognition model to perform the object class prediction.

11. A non-transitory computer-readable storage medium, having computer instructions stored thereon, wherein when the computer instructions are executed, a computer is caused to implement an object detecting method, wherein the method comprises:
obtaining an object image;
obtaining an object feature map by performing feature extraction on the object image;
obtaining decoded features by performing feature mapping on the object feature map by adopting on a mapping network of an object recognition model;
obtaining positions of prediction boxes by inputting the decoded features into a first prediction layer of the object recognition model to perform object regression prediction; and
obtaining classes of objects within the prediction boxes by inputting the decoded features into a second prediction layer of the object recognition model to perform object class prediction.

12. The non-transitory computer-readable storage medium of claim 11, wherein obtaining the decoded features comprises:
obtaining an input feature map by fusing the object feature map and a corresponding position map, wherein elements of the position map correspond to elements of the object feature map respectively, and the element of the position map is configured to indicate a coordinate, in the object image, of the corresponding element of the object feature map; and
obtaining the decoded features by inputting the input feature map into the mapping network of the object recognition model.

13. The non-transitory computer-readable storage medium of claim 12, wherein obtaining the decoded features by inputting the input feature map into the mapping network of the object recognition model comprises:
obtaining encoded features by inputting the input feature map into an encoder of the object recognition model for encoding; and
obtaining the decoded features by inputting the encoded features into a decoder of the object recognition model for decoding.

14. The non-transitory computer-readable storage medium of claim 11, wherein obtaining the positions of the prediction boxes comprises:
inputting feature dimensions in the decoded features into respective feed-forward neural networks in the first prediction layer of the object recognition model to perform the object regression prediction to obtain the positions of the prediction boxes.

15. The non-transitory computer-readable storage medium of claim 11, wherein obtaining the classes of the objects within the prediction boxes comprises:
obtaining the classes of the objects by inputting feature dimensions in the decoded features into respective feed-forward neural networks in the second prediction layer of the object recognition model to perform the object class prediction.
